(19) United States
(12) Patent Application Publication
(10) Pub. No.: US 2004/0200026 A1
(43) Pub. Date: Oct. 14, 2004

(54) Retention member for a windshield wiper assembly

(76) Inventor: Subramaniam Shanmugham, Fort Worth, TX (US)

Correspondence Address: PATTON BOGGS, 1660 LINCOLN ST, SUITE 2050, DENVER, CO, 80264, US

(21) Appl. No.: 10/412,495

(22) Filed: Apr. 12, 2003

(51) Int. Cl. B60S 1/38

(52) U.S. Cl. 15/250.452; 15/250.451

(57) ABSTRACT

A retention member having an upper plate, an end tab, and a pair of retaining legs is provided. The end tab is integrally connected to a first end of the upper plate. The retaining legs are connected to opposing sides of the upper plate at a second end of the upper plate. A leg protrusion member extends inwardly from each retaining leg. The retention member is installed on an end of a wiper blade and vertebra to secure the wiper blade and vertebra to a wiper frame.

### BACKGROUND OF THE INVENTION

1. Field of the Invention

This invention relates generally to windshield wiper assemblies, and more particularly to a retention member for securing a wiper blade and vertebra to a wiper frame.

2. Description of Related Art

A critical problem encountered by windshield wiper designers has been how to maintain contact between a wiper blade and a windshield at all times throughout the windshield wiping process. One complicating factor is that a particular wiper blade may be designed to fit on many different automobile models. Different automobiles typically have windshields of different sizes and shapes, and providing contact between the windshield and all parts of a wiper blade can be a difficult task. One design solution to the problem has been to provide wiper frames having spring-like flexural members attached to the frames. The flexural members exert forces at various points along the wiper blade to insure contact of the blade with the windshield.

The wiper blade portion of a windshield wiper assembly typically is made of an elastomeric material and includes a wiping portion and a head portion. The head portion of the wiper blade attaches to the frame of the wiper assembly, and it is typically desirable to include a stiffening member, which improves the connection between the wiper blade and the frame. The stiffening member, often referred to as a spline or vertebra, adds rigidity to the head portion of the wiper blade, and helps insure that the wiper blade conforms to the curvature of the windshield.

Referring to FIG. 13, wiper blade 301 includes a head portion 303 and a wiping portion 305. Wiper blade 301 is attached to a wiper frame 307. Wiper frame 307 is rotated to drag wiping portion 305 across a wiping surface 311, such as a windshield. The method of attaching wiper blade 301 to wiper frame 307 can greatly affect the performance of the wiper blade in cleaning wiping surface 311. As previously mentioned, many wiping surfaces 311 are curved, and it is essential that the wiper blade 301 conform to the shape of the wiping surface 311.

FIG. 13 illustrates some of the performance and design issues associated with wiper blades. Wiper blade 301 includes a groove 315 on opposing sides of the head portion 303. A lower portion of a spline 317 is received by the grooves 315. Wiper blade 301 is attached to wiper frame 307 using claws 319 that surround and grip an upper portion of spline 317. In order to prevent the wiper blade 301 and spline 317 from sliding out of the claws 319, an end cap (not shown) is generally connected to the claw at each end of the wiper blade. Splines such as spline 317 surround the entire head portion of the wiper blade 301 and are very restrictive of the “rolling” ability of the wiper blade. As illustrated in FIG. 13, as the wiper blade 301 is dragged across the wiping surface 311, the wiping portion 305 “rolls” to one side, and then to the other side as the motion of the wiper blade 301 is reversed. Excess restriction on the head portion of the wiper blade by the spline can degrade the rolling ability of the blade. Additionally, the attachment of end caps to the claws of the wiper frame can decrease rolling in the area of the claw. Decreased rolling ability decreases the wiping effectiveness of the blade and can produce “chatter” as the wiper is dragged across the wiping surface.

Several different methods are used to attach wiper blades to frames, but these methods typically involve either crimping the claws to the wiper blade and spline assembly or attaching an end cap to the wiper blade and claw near an end of the wiper blade. Both of these attachment methods tend to limit rotational movement of the wiper blade relative to the frame, which decreases the rolling ability of the wiper blade. Furthermore, these attachment methods can limit the ability of the wiper blade to move longitudinally relative to the spline, which decreases the wiper blade's ability to conform to the wiping surface.

A need exists, therefore, for a windshield wiper having a wiper blade that is attached to the wiper frame in a way that does not limit the rolling movement of the wiper blade relative to the frame and that does not limit the longitudinal movement of the wiper blade relative to the spline or vertebra. More specifically, a retention member is needed that allows a wiper blade to be slidingly installed within the claws of a wiper frame, but does not attach directly to any of the claws. Finally, a retention member is needed that is constructed of a rugged material that is not susceptible to extreme changes in temperature or subject to extreme deformation or damage when the wiper is dropped.

### BRIEF SUMMARY OF THE INVENTION

The problems presented by traditional wiper blade attachment devices and methods are solved by the present invention. In a preferred embodiment, a wiper blade retention member having an upper plate, an end tab, and a pair of retaining legs is provided. The end tab is connected to a first end of the upper plate, and the retaining legs are connected on opposing sides of the upper plate at a second end. Each retaining leg includes a leg protrusion member.

The invention further provides a wiper blade assembly that includes a wiper blade, vertebras positioned within upper recesses on the wiper blade, and a retention member for securing the wiper blade and the vertebras to a wiper frame. The retention member includes an upper plate, an end tab, and a pair of retaining legs. The end tab is connected to a first end of the upper plate, and the retaining legs are connected on opposing sides of the upper plate at a second end. Each retaining leg includes a leg protrusion member. When installed, the end tab is outside of and adjacent to an end surface of the wiper blade and an end surface of the vertebra. The retaining legs are at least partially received by slots on the vertebra which assists in securing the retention member to the wiper blade. The leg protrusion members are received by lower recesses on the wiper blade.

Other objects, features, and advantages of the present invention will become apparent with reference to the drawings and detailed description that follow.

### BRIEF DESCRIPTION OF THE DRAWINGS

FIG. 1 illustrates a front view of a wiper assembly according to the present invention, the wiper assembly including a wiper frame having blade-receiving members, a wiper blade, a vertebra, and a retention member;

FIG. 2 depicts a front view of the wiper assembly of FIG. 1 taken at Detail A;

FIG. 3 illustrates a perspective view of the wiper blade and vertebra of FIG. 1;

FIG. 4 depicts a perspective view of the retention member of FIG. 1, the retention member having a pair of leg protrusion members;

FIG. 5 illustrates a front view of the retention member of FIG. 4;

FIG. 6 depicts a bottom view of the retention member of FIG. 4;

FIG. 6A depicts a bottom view of an alternate embodiment of the leg protrusion members of FIG. 4;

FIG. 7 illustrates a perspective view of a retention member according to an alternate embodiment of the present invention;

FIG. 8 depicts a front view of the retention member of FIG. 7;

FIG. 9 illustrates a cross-sectional side view of the retention member of FIG. 7 taken at IX-IX;

FIG. 10 depicts a perspective view of a retention member according to an alternate embodiment of the present invention;

FIG. 11 illustrates a front view of the retention member of FIG. 10;

FIG. 12 depicts a cross-sectional bottom view of the retention member of FIG. 10 taken at XII-XII; and

FIG. 13 illustrates a perspective view of a prior art windshield wiper assembly.

### DETAILED DESCRIPTION OF THE PREFERRED EMBODIMENT

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical, structural, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

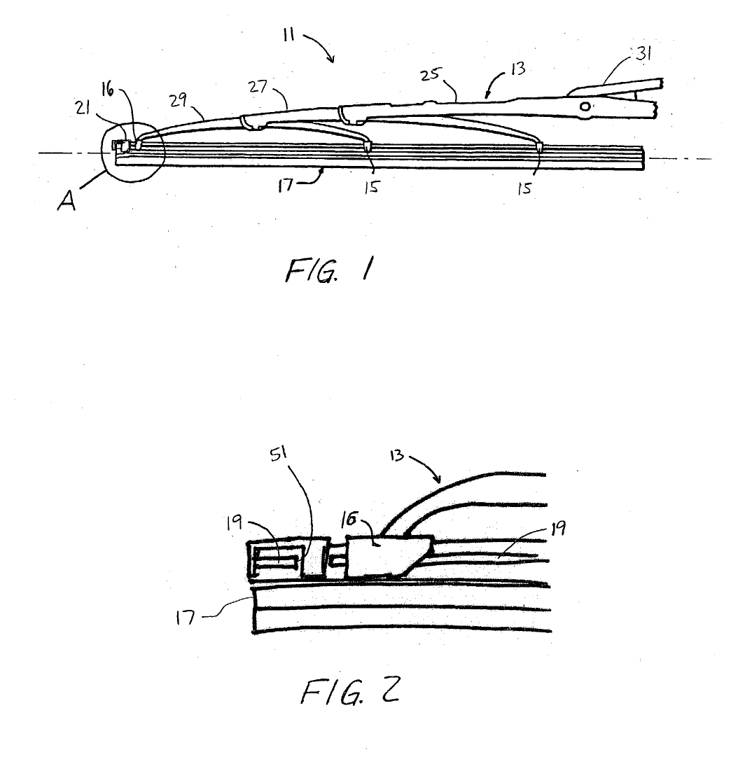

Referring to FIGS. 1 and 2, a wiper assembly 11 includes a wiper frame 13, a plurality of blade-receiving members 15, a wiper blade 17, a vertebra 19, and a wiper blade retention member 21. Wiper blade 17 and vertebra 19 are slidingly received by the blade-receiving members 15, or claws, disposed on wiper frame 13. Each wiper frame 13 includes two distal claws 16, which are the claws nearest the ends of wiper blade 17 (only one distal claw 16 is illustrated in FIG. 1). Wiper frame 13 is of traditional design and includes a primary frame portion 25, two secondary frame portions 27, and a plurality of tertiary frame portions 29. Secondary and tertiary frame portions 27, 29, also referred to as “bridges,” are flexural members that help maintain contact between wiper blade 17 and a wiping surface or windshield (not shown). Secondary frame portions 27 are pivotally connected to both ends of primary frame portion 25. Tertiary frame portions 29 are pivotally connected to each end of the secondary frame portions 27. Together, the primary, secondary, and tertiary frame portions exert forces on multiple portions of wiper blade 17 so that the wiper blade 17 contacts, and thereby wipes, a windshield more effectively.

When installed on an automobile, airplane or other vehicle having a windshield, the primary frame portion 25 is pivotally connected to a wiper arm 31. The wiper arm either rotates or translates relative to the windshield such that the wiper blade 17 is dragged across the surface of the windshield. As the wiper blade 17 moves across a windshield having a contour, the force exerted at the end of each frame portion (i.e. primary 25, secondary 27, or tertiary 29) coupled with the ability of each frame portion to pivot relative to the wiper arm and the other frame portions allows the wiper blade 17 to bend and conform to the shape of the windshield.

Although wiper blade 17 is designed to flex and conform to the shape of a contoured surface, it is preferred that wiper blade 17 retain some spring-like rigidity to oppose the forces imposed by the contoured surface, as well as the primary, secondary, and tertiary frame portions. The wiper blade rigidity further assists in providing full contact between the wiper blade 17 and the surface being wiped. Wiper blade 17 is combined with a two-piece vertebra 19 to provide the required rigidity along the length of wiper blade 17.

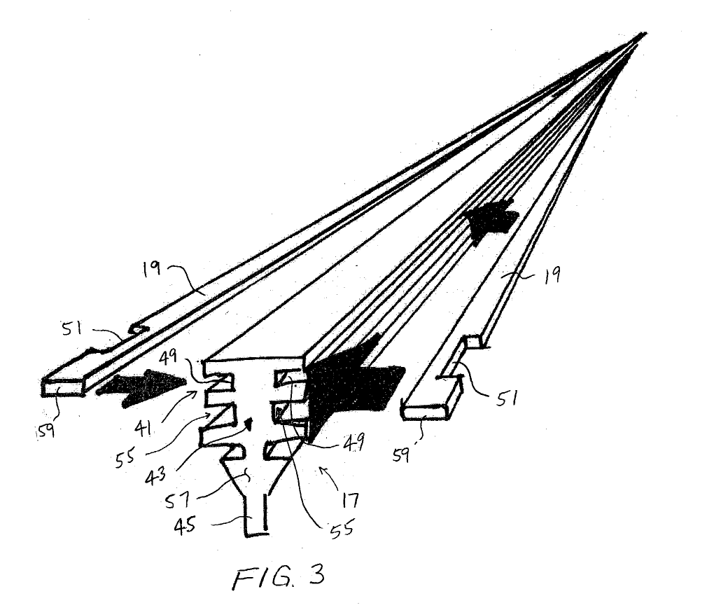

Referring to FIG. 3, wiper blade 17 includes a head portion 41, a neck portion 43, and a wiping portion 45. A lower pair of longitudinal recesses 55 is disposed on the head portion 41. Head portion 41 also includes an upper pair of longitudinal recesses 49, one on each side of the wiper blade 17. Each upper longitudinal recess 49 is adapted to receive one of the vertebra 19. Each vertebra 19 includes two slots 51, each slot 51 being disposed proximate an end surface 59 of the vertebra 19 such that the slot 51 is located between the distal claw 16 (see FIG. 2) and an end surface 57 of the wiper blade 17 when the vertebra is installed on the wiper blade 17 (see FIG. 2). As illustrated in FIG. 3, each vertebra is received by one of the upper recesses 49. The installation of the vertebra 19 in the recess 49 of the wiper blade 17 causes the wiper blade to become more rigid, which facilitates connection of the wiper blade 17 to wiper frame 13 and enables the wiper blade 17 to better conform to the contour of the wiping surface.

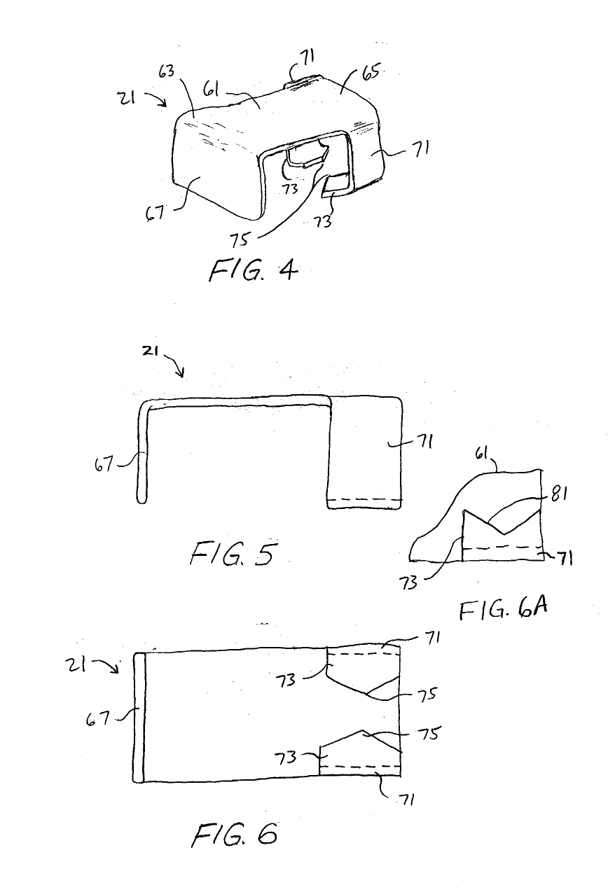

Referring to FIGS. 4, 5, and 6, a preferred embodiment of the retention member 21 is illustrated. Retention member 21 includes a substantially planar upper plate 61 having a first end 63 and a second end 65. An end tab 67 is integrally connected to the upper plate 61 at the first end, and a pair of retaining legs 71 are integrally connected on opposing sides of the upper plate 61 at the second end 65. Both the end tab 67 and the retaining legs 71 extend downward from the upper plate 61. A leg protrusion member 73 extends inward from an end of each retaining leg 71 opposite the upper plate 61. Preferably the leg protrusion members 73 are substantially parallel to the upper plate 61 and terminate in a v-shaped apex 75.

In a preferred embodiment, the retention member 21 is constructed from a single, integral piece of stainless steel. A person having ordinary skill in the art will recognize, however, that the retention member 21 could be constructed of high-impact plastic or any other material that offers strength and rigidity. Similarly, the end tab 67 and retaining legs 71 do not necessarily have to be integrally attached to the upper plate 61, but instead could be attached by some type of fastening, welding, or bonding means. It is also preferable to coat the retention member in a black, powder coat material to reduce glare or reflection of light.

In operation, the wiper blade retention member 21 is used to prevent the wiper blade 17 and vertebra 19 from becoming disengaged from one another and from becoming disengaged from claws 15, 16. Preferably, claws 15, 16 form a c-shaped channel that receives the wiper blade 17. Tabs (not shown) on each claw are received by the lower pair of recesses 55 (see FIG. 3) on the wiper blade 17. Claws 15, 16 are sized such that the tabs of the claws adequately engage the recesses 55 to prevent the wiper blade 17 from becoming disengaged from the claws. However, the claws are also sized large enough to allow some clearance between the claw and the wiper blade. The clearance between the claws and the wiper blade is such that the wiper blade 17 is still capable of “rolling” or rotational motion in a location proximate the claw. This rolling motion is very important to the performance of the wiper blade, since the wiper blade must able to “roll” as the direction of the wiper's blade motion across the wiping surface is changed. Inadequate rolling prevents effective wiping and can also cause “chatter” as the wiper blade moves across the wiping surface.

The wiper blade retention member 21 is installed on the wiper blade 17 such that the leg protrusion members 73 are received by the lower pair of recesses 55 on the wiper blade 17. The first and second legs 71 perform a similar function to claws 15, 16, since the legs prevent the vertebra 19 from becoming disengaged from the wiper blade due to lateral movement within the upper pair of recesses 49. The retention member 21 is installed on each end of the wiper blade 17 such that each of the legs 71 is at least partially received by one of the slots 51 on the vertebra 19. By engaging the slots 51, the retention member 21 is prevented from sliding off of the end of the wiper blade 17. End tab 67 is positioned outside of and adjacent to the end surface 57 of the wiper blade 17 and the end surface 59 of the vertebras 19 (see FIGS. 2 and 3). When the retention member 21 is locked in place (by placing the legs 71 within the slots 51), the end tab 67 prevents the vertebras 19 from becoming disengaged from the wiper blade by longitudinal movement within the upper pair of recesses 49. The end tab 67 also serves to protect the wiper blade 17 and vertebra 19 if the wiper assembly is dropped.

The v-shaped apex 75 of each leg protrusion member 73 is provided to minimize surface area contact between the leg protrusion member 73 and the wiper blade 17. Since the leg protrusion members 73 are generally formed by bending the lower ends of the retaining legs 71 during installation on the wiper blade 17, the leg protrusion members 73 could have a tendency to contact, and even pinch, the neck 43 of the wiper blade 17 in the area of the lower recesses 55. By minimizing the surface area contact with the wiper blade 17, the blade's ability to roll or rotate relative to the wiper frame in the area of the retention member 21 is increased. It should be noted, however, that other designs could also be used to limit the contact between wiper retention member 21 and the neck 43 of the wiper blade 17. Referring to FIG. 6A, an inverted v-shaped end 81 could be provided that has only two points of contact with the neck 43 of the wiper blade 17. Alternatively, a flat end (not shown) could be provided and an attempt made to minimize contact between the flat end and the neck 43 of the wiper blade 17.

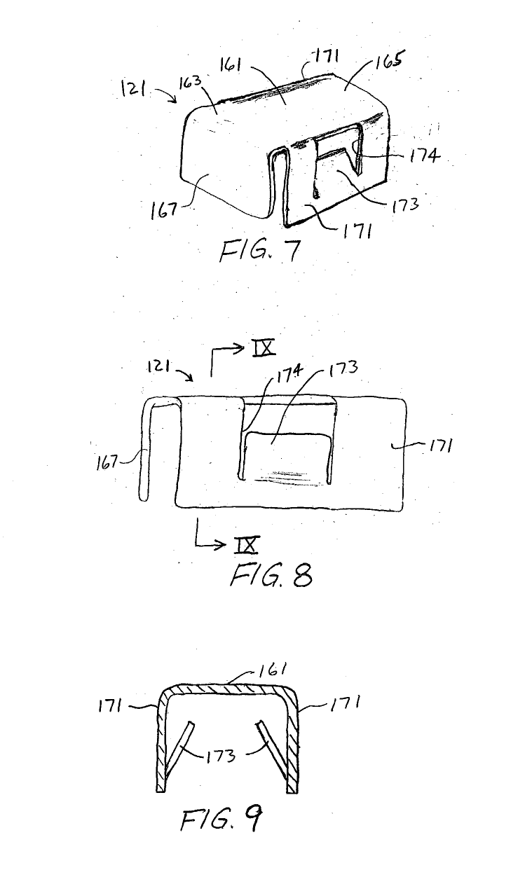

Referring to FIGS. 7, 8, and 9, another embodiment of a wiper retention member 121 is illustrated. Retention member 121 includes a substantially planar upper plate 161 having a first end 163 and a second end 165. An end tab 167 is connected to the upper plate 161 at the first end 163, and a pair of retaining legs 171 are connected on opposing sides of the upper plate 161. Both the end tab 167 and the retaining legs 171 extend downward from the upper plate 161. A leg protrusion member 173 extends inward from each retaining leg 171. Unlike the protrusion members 73 of retention member 21, the leg protrusion members 173 are not parallel to the upper plate 161, but are angled upward and inward from a lower portion of a relief aperture 174 on the retaining leg 171.

In a preferred embodiment, the retention member 121 is constructed from a single, integral piece of stainless steel. A person having ordinary skill in the art will recognize, however, that the retention member 121 could be constructed of high-impact plastic or any other material that offers strength and rigidity. Similarly, the end tab 167 and retaining legs 171 do not necessarily have to be integrally attached to the upper plate 161, but instead could be attached by some type of fastening, welding, or bonding means.

In operation, the wiper blade retention member 121 is installed similarly to wiper blade retention member 21. One similar aspect is that the wiper blade retention member 121 is not physically attached to any of the claws 15, 16. This allows maximum rotational movement of the wiper blade 17 in the area of the claws 15, 16 and the retention member 121. The first and second legs 171 perform a similar function to claws 15, 16, since the legs 171 prevent the vertebra 19 from becoming disengaged from the wiper blade due to lateral movement within the upper pair of recesses 49. The retention member 121 is installed on each end of the wiper blade 17 such that each of the leg protrusion members 173 is at least partially received by one of the slots 51 on the vertebra 19. By engaging the slots 51, the retention member 121 is prevented from pulling away from the end of the wiper blade 17. End tab 167 is positioned outside of and adjacent to the end surface 57 of the wiper blade 17 and the end surface 59 of the vertebras 19 (see FIGS. 2 and 3). When the retention member 121 is locked in place, the end tab 167 prevents the vertebras 19 from becoming disengaged from the wiper blade 17 by longitudinal movement within the upper pair of recesses 49. The end tab 167 also serves to protect the wiper blade 17 and vertebra 19 if the wiper assembly is dropped.

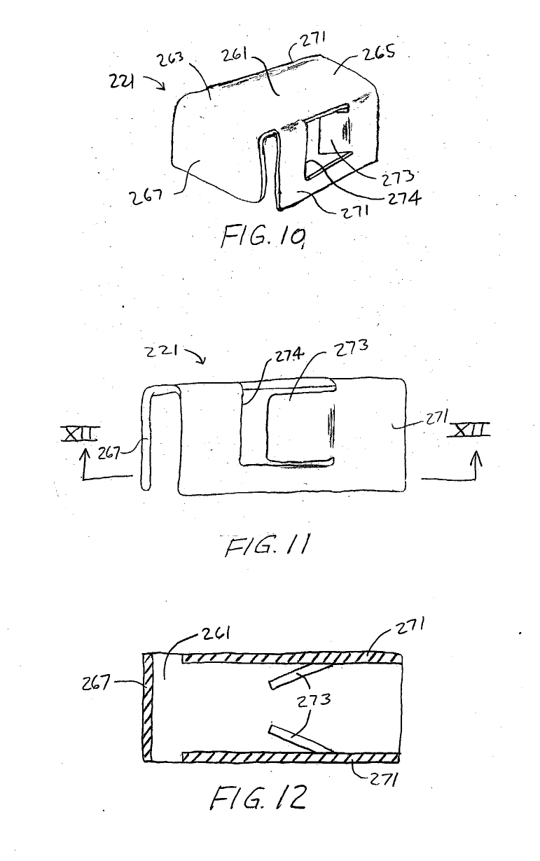

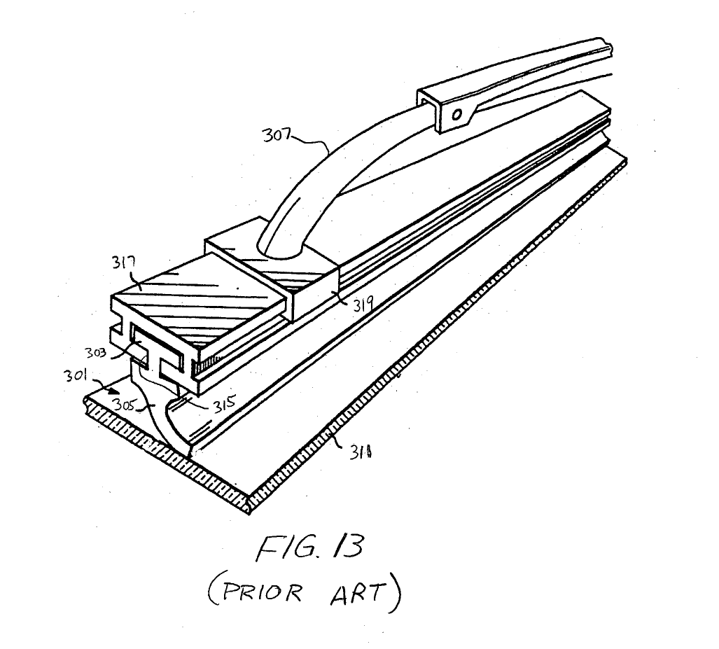

Referring to FIGS. 10, 11, and 12, another embodiment of a wiper retention member 221 is illustrated. Retention member 221 includes a substantially planar upper plate 261 having a first end 263 and a second end 265. An end tab 267 is connected to the upper plate 261 at the first end 263, and a pair of retaining legs 271 are connected on opposing sides of the upper plate 261. Both the end tab 267 and the retaining legs 271 extend downward from the upper plate 261. A leg protrusion member 273 extends inward from each retaining leg 271. Unlike the protrusion members 73 of retention member 21, the leg protrusion members 273 are not parallel to the upper plate 261, but are angled forward and inward from a rear portion of a relief aperture 274 on the retaining leg 271.

In a preferred embodiment, the retention member 221 is constructed from a single, integral piece of stainless steel. A person having ordinary skill in the art will recognize, however, that the retention member 221 could be constructed of high-impact plastic or any other material that offers strength and rigidity. Similarly, the end tab 267 and retaining legs 271 do not necessarily have to be integrally attached to the upper plate 261, but instead could be attached by some type of fastening, welding, or bonding means.

In operation, the wiper blade retention member 221 is installed similar to wiper blade retention member 21. One similar aspect is that the wiper blade retention member 221 is not physically attached to any of the claws 15, 16. This allows maximum rotational movement of the wiper blade in the area of the claws 15, 16 and the retention member 221. The first and second legs 271 perform a similar function to claws 15, 16, since the legs 271 prevent the vertebra 19 from becoming disengaged from the wiper blade 17 due to lateral movement within the upper pair of recesses 49. The retention member 221 is installed on each end of the wiper blade 17 such that each of the leg protrusion members 273 is at least partially received by one of the slots 51 on the vertebra 19. By engaging the slots 51, the retention member 221 is prevented from pulling away from the end of the wiper blade 17. End tab 267 is positioned outside of and adjacent to the end surface 57 of the wiper blade 17 and the end surface 59 of the vertebras 19 (see FIGS. 2 and 3). When the retention member is locked in place, the end tab 267 prevents the vertebras 19 from becoming disengaged from the wiper blade 17 by longitudinal movement within the upper pair of recesses 49. The end tab 267 also serves to protect the wiper blade 17 and vertebra 19 if the wiper assembly is dropped.

From the foregoing, it will be recognized that the wiper blade, vertebra, and retention member of the present invention provide a superior system for increasing the wiping performance of a wiper blade. By using a retention member to secure the wiper blade and vertebra within the claws of a wiper frame, the claws can slidingly receive the wiper blade and the vertebra, and no crimping of the claws to the blade is required. This assists in maintaining the rolling ability of the wiper blade in the area proximate the claws. The rolling ability is also aided by not attaching the retention member to the distal claws of the wiper frame. Finally, since in the preferred embodiment the width of the vertebra slot is slightly larger than the width of the retaining legs, the vertebra is allowed to move more easily in a longitudinal direction relative to the wiper blade. This is especially important when the wiper blade assembly is wet, since the friction between the wiper blade and the vertebra is significantly reduced at that time. Longitudinal movement of the wiper blade relative to the vertebra allows the wiper blade to more easily conform to the contour of a wiping surface, which further improves performance of the wiper blade.

Another advantage provided by the present invention is the increased durability of the wiper blade retention member. The retention member is preferably made of stainless steel, which is significantly stronger than the plastic “end caps” used with many wiper blades. Since wiper blades are sometimes dropped prior to installation, it is common to perform “drop tests” on wiper blades to test the overall resistance of the wiper blades to breakage. In drop tests having an impact point on the end of the wiper blade, plastic end caps are especially susceptible to breakage. The retention member of the present invention exhibits very good resistance to deformation and breakage. When subjected to drop tests, the end tab typically strikes the ground first, and the impact energy is transferred through the legs and into the vertebras through the vertebra slots. Since the vertebras absorb most of the impact and are relatively restrained by the claws, the damage to the retention member and the wiper blade assembly is minimal.

Still another advantage of the present invention is provided by the simple, sleek design of the retention member. The retention member is very compact and is therefore aesthetically pleasing when installed on a wiper blade. Because of the simplicity of the retention member's design, it is also relatively easy and inexpensive to manufacture.

It should be apparent from the foregoing specification that an invention having significant advantages has been provided. While the invention is shown in only a few of its forms, it is not just limited but is susceptible to various changes and modifications without departing from the spirit thereof.

I claim:

1. A wiper blade retention member for securing a wiper blade and a vertebra to a wiper frame, the retention member comprising:
an upper plate;
an end tab connected to the upper plate;
a first and second leg connected to the upper plate on opposing lateral sides of the upper plate;
a leg protrusion member connected to each of the first and second legs; and
wherein the end tab is adapted for positioning on the wiper blade such that the end tab is disposed adjacent to and outside of an end surface of the vertebra.

2. A wiper blade retention member according to claim 1, wherein the leg protrusion member terminates in a v-shaped apex.

3. A wiper blade retention member according to claim 1, wherein the leg protrusion member terminates in an inverted v-shaped end.

4. A wiper blade assembly for attachment to a wiper frame, the wiper blade assembly comprising:
a wiper blade;
a pair of vertebra positioned within upper recesses of the wiper blade, each vertebra having a slot;
a retention member having an upper plate, an end tab connected to the upper plate, a first and second leg connected to the upper plate on opposing lateral sides of the upper plate, and a leg protrusion member connected to each of the first and second legs; and
wherein the retention member is positioned on an end of the wiper blade such that the end tab is disposed adjacent to and outside of an end surface of the vertebra and such that the first and second legs of the retention member are at least partially received by the slots on the vertebra.

5. A wiper blade assembly according to claim 4, wherein the slot on each vertebra is sized wider than the width of one of the first and second legs.

6. A wiper blade assembly according to claim 4, wherein:
the wiper blade and vertebra are received by a plurality of claws on the wiper frame; and
the retention member is not connected to any of the claws.

7. A wiper blade assembly according to claim 4, wherein the leg protrusion member terminates in a v-shaped apex.

8. A wiper blade assembly according to claim 4, wherein the leg protrusion member terminates in an inverted v-shaped end.

9. A wiper blade assembly for attachment to a wiper frame, the wiper blade assembly comprising:
a wiper blade having a wiping portion connected to a head portion by a neck portion, the head portion having an upper recess on each side of the neck portion;
a vertebra positioned within each upper recess, each vertebra including a slot that is oriented opposite the neck portion of the wiper blade when the vertebra is positioned in the vertebra channel;
a retention member having an upper plate, an end tab connected to the upper plate, a first and second leg connected to the upper plate on opposing lateral sides of the upper plate, and a leg protrusion member connected to each of the first and second legs; and
wherein the retention member is positioned on an end of the wiper blade such that the end tab is disposed adjacent to and outside of an end surface of the vertebra and such that the first and second legs of the retention member are at least partially received by the slots on the vertebra.

10. A wiper blade assembly according to claim 9, wherein the slot on each vertebra is sized wider than the width of one of the first and second legs.

11. A wiper blade assembly according to claim 9, wherein:
wiper blade and vertebra are received by a plurality of claws on the wiper frame; and
retention member is not connected to any of the claws.

12. A wiper blade assembly according to claim 9, wherein the leg protrusion member terminates in a v-shaped apex.

13. A wiper blade assembly according to claim 9, wherein the leg protrusion member terminates in an inverted v-shaped end.
